(19) United States
(12) Patent Application Publication
(10) Pub. No.: US 2004/0193495 A1
(43) Pub. Date: Sep. 30, 2004

(54) Method and system for responsibly selling food to customers

(76) Inventor: Richard C. Kim, San Diego, CA (US)

Correspondence Address: Richard C. Kim, 14232 Half Moon Bay Drive, Del Mar, CA, 92014, US

(21) Appl. No.: 10/741,406

(22) Filed: Dec. 19, 2003

Related U.S. Application Data
(60) Provisional application No. 60/435,265, filed on Dec. 23, 2002.

(51) Int. Cl. G06F 17/60

(52) U.S. Cl. 705/15

(57) ABSTRACT

The invention relates to a new method and system for selling food to customers wherein nutritional information such as calories, fat content, carbohydrate content, etc., for a meal ordered by the customer is automatically accessed from a memory and thereafter provided to the customer.

### RELATED APPLICATIONS

This application claims the benefit of priority under 35 U.S.C. § 119(e) to U.S. provisional application serial No. 60/435,265, filed Dec. 20, 2002, entitled “Method And System For Responsibly Selling Food To Customers.”

### BACKGROUND OF THE INVENTION

1. Field of the Invention

The present invention relates to a revolutionary method and system for selling food to customers in a restaurant environment. In particular, the invention relates to a method and system for automatically providing desired nutritional information of menu food items ordered by the customer so as to provide important dietary information to customers who are health conscious but also enjoy purchasing meals from restaurants.

2. Description of the Related Art

There is currently an epidemic of obesity in the United States. It is estimated that approximately 60% of Americans today are overweight or obese. Additionally, obesity is a leading factor in increased health care costs and is second only to cigarette smoking as a preventable cause of death. It is estimated that obesity-related disease leads to a 36% increase in in-patient and out-patient health care costs and a 77% increase in prescription medication costs when compared to the same costs for normal weight individuals. This epidemic exists despite the fact that two-thirds of the U.S. population actively attempts to lose weight or prevent weight gain and despite the fact that it is estimated that American's spend more than $30 Billion per year in weight control programs and products.

A primary contributing factor to the obesity epidemic is believed to be the increase in the consumption of food from fast food restaurants. It has been reported that the amount of money spent on fast food by American consumers has increased from $ 6 Billion in 1970 to over a $ 110 Billion in 2000. Although many people attempt to be health conscience, as described above, often times the convenience (e.g., price and time) of fast food overrides their nutritional concerns. In most cases, these people purchase and eat food without knowing its nutritional content or even the appropriate portions to eat. As a result, consumers of fast food are not adequately informed of the potential health risks associated with the foods they are eating. It is interesting to note that laws have been passed requiring cigarette and alcohol manufacturers and/or distributors to place warning labels on their products to inform and/or remind their consumers of the adverse health consequences of what they are consuming. However, no similar laws have been passed requiring fast food manufacturers to provide similar information about fast food products that may lead to detrimental health consequences such as obesity, heart disease, diabetes, etc.

Regardless of whether a mandatory warning requirement is imposed upon restaurants, many consumers would nevertheless desire to obtain nutritional information about food products they purchase and consume. Restaurants today, however, do not provide nutritional information about the foods purchased by consumers in an efficient, convenient and consistent manner. Some restaurants such as Subway™, for example, provide a pre-printed nutritional brochure or pamphlet that lists calorie and/or fat content information for one or more menu items. However, this pre-printed brochure is typically only provided upon request by the consumer and requires a consumer to find each of his or her selected items on the brochure and perform manual calculations to determine the total nutritional values of the food items they are purchasing. For example, if a consumer purchases a sandwich, potato chips, a soft drink and a cookie, and desires to obtain nutritional information for this meal, the consumer is required to perform the following tasks:

1. Request and/or manually retrieve a hardcopy pamphlet or menu containing nutritional information for various food items;

2. Locate each of the specific menu items ordered in the pamphlet; and

3. Manually calculate the total nutritional values for each desired nutrition parameter (e.g., calories and/or fat content) for the entire meal.

Although the above steps may at first impression seem fairly simple to perform (assuming a particular restaurant has such pamphlets available), a predominant majority of consumers do not perform them. Although the reasons for such failure necessarily vary from consumer to consumer, generally, the reason is that consumers find it inconvenient or simply forget to perform the above tasks. This is especially true for customers of fast food restaurants whose primary concern is price and speed when purchasing food. Additionally, for consumers who are not proficient in performing mathematical operations manually (i.e., “in their heads”), the difficulty of manually calculating total nutritional values for a plurality of menu items constitutes a further inconvenience. The difficulty and inconvenience increases as the number of menu items ordered increases and the number of desired nutritional parameters increases. Furthermore, most restaurants only provide limited nutritional information in their brochures such as calories and fat. If a consumer desired to customize his or her nutritional information or desired to know less commonly sought nutritional facts about the food that is ordered, such as sodium, carbohydrate, protein, sugar, iron and mineral levels, for example, in most cases, this information is unavailable.

With the fast pace of life today and the busy schedules of consumers, nutritional awareness often takes a back seat to price and speed for most people, especially those that patronize fast food restaurants. Therefore, what is needed is a method and system for automatically and conveniently providing nutritional information for meals purchased in restaurants. Such a system would increase nutritional awareness and help individuals monitor their fast food nutritional intake in an efficient and consistent manner. Even consumers who do not currently care about the nutritional content of the food they eat would benefit by at least being better informed. At the very least, it would make such people more aware of what they are putting into their bodies and the potential health consequences of doing so.

### BRIEF SUMMARY OF THE INVENTION

The present invention addresses the above and other needs by providing a method and system that automatically calculates a total price of food items ordered by a restaurant customer and additionally automatically calculates a total nutritional value for at least one nutritional parameter associated with the food items.

In one embodiment, the invention includes a memory for storing a list of menu items, price information for each menu item, and at least one nutritional parameter value for each menu item. A microprocessor is coupled to this memory for accessing information therein and performing calculations based on price information and nutritional parameter values. The invention further includes a keyboard or other input device, coupled to the microprocessor, which allows a user to select desired food menu items. Upon receiving the user's selections of desired menu items, the microprocessor accesses price information and nutritional parameter values corresponding to the selected items and calculates a total price and a total nutritional parameter value for the selected menu items.

In an additional embodiment, the system further includes a display, coupled to the microprocessor, for displaying price information and nutritional information for each food item selected by the user, and total price and nutritional value(s) for all or a desired subset of the food items. In a further embodiment, this display could be located outside of the restaurant as part of a “drive-thru” ordering system, wherein the display provides the above mentioned price and nutritional information to customers as they order food through the “drive-thru” ordering system. “Drive-thru” systems are ubiquitous today. However, such systems do not currently display nutritional information and/or automatically calculate and display total nutritional parameter values corresponding to a meal ordered by customers.

In a further embodiment, the system includes a printer, coupled to the microprocessor, for printing price information and nutritional information and/or total price and total nutritional information for at least one nutrition parameter for a meal ordered by a customer.

In yet a further embodiment, the system can provide nutritional information for nutrition parameters requested by a customer. For example, if a customer desires to know the carbohydrate information associated with his or her meal, the customer can request this information. Thereafter, the user (e.g., restaurant employee/cashier) will select an appropriate key (or keys) on the keyboard to retrieve carbohydrate values for each food item ordered by the customer and/or calculate a total carbohydrate value for all food items ordered. This information is then printed on the customer's receipt and/or displayed on the display.

### BRIEF DESCRIPTION OF THE DRAWINGS

FIG. 1 illustrates a block diagram of a system of providing price and nutrition information for food items ordered by a customer, in accordance with one embodiment of the invention.

FIG. 2 illustrates an exemplary display that provides price and nutrition information for a meal ordered by a customer, in accordance with one embodiment of the invention.

### DETAILED DESCRIPTION OF THE PREFERRED EMBODIMENTS

The invention is described in detail below with reference to the figures, wherein like elements are referenced with like numerals throughout.

In one preferred embodiment of the invention, the system 10 includes a memory 12 for storing a plurality of food menu items sold by a restaurant or other food outlet. In the preferred embodiment, the memory 12 is a non-volatile, programmable memory (e.g., Flash memory manufactured by Toshiba Corporation) that further stores for each menu item corresponding price information and at least one nutritional parameter value. In other embodiments, the memory 12 can be non-volatile and non-programmable, such as a read only memory (ROM). As used herein, a “nutritional parameter” is any nutritional characteristic or content information associated with a given food item, which includes but is not limited to the following parameters: calories, fat (saturated, mono-unsaturated, poly-unsaturated, etc.), protein, carbohydrate, cholesterol, sodium, sugar, vitamin(s), calcium, mineral, iron, and other known nutritional characteristics of food. A “nutritional value” or “nutritional parameter value” refers to any type of numeric or quantitative information associated with a nutritional parameter.

In a preferred embodiment, each menu item and associated price and nutritional information is stored in the memory 12 in a database format, or other known relational format (e.g., spread sheet format), such that the information may be manipulated and accessed as desired by the user of the system. For example, if the user desires price and carbohydrate information only for selected menu items, the specified information can be identified and retrieved from the memory 12. Additionally, if the memory 12 is programmable, the user can store additional menu items and associated price and nutritional information into the memory 12, for later retrieval.

The system further includes a computer or microprocessor 14, coupled to the memory 12, for accessing information requested by a user of the system and processing information/requests entered by the user via a keyboard 16, or other known data input device. At the very least, the computer 14 includes processing circuitry (not shown) and associated software or firmware, to perform the functions of information retrieval and processing (e.g., calculation of total price and total nutritional values). The computer 14 further includes other circuitry (not shown) and associated software and/or firmware for printing information via a printer 18 and/or displaying information via a display 20. Such types of processing circuitry and associated software/firmware is rudimentary and ubiquitous in personal computers and even in some cash register systems of restaurants today. However, as mentioned above, no current systems automatically provide and display both price and nutritional information to customers in a restaurant environment.

The computer/microprocessor 14 executes software and/or firmware for processing user requests/selections of food items and thereafter retrieving the corresponding price and nutritional information from memory 12. In one embodiment, the software further allows the computer 14 to store information pertaining to additional menu items, entered by the user, in the memory 12 in a desired format. Such software, as required for the present invention, would be easily implemented by those of ordinary skill in the art and need not be further explained in detail herein. In one embodiment, the software is stored in a ROM (not shown) for execution by the microprocessor of the computer 14. This ROM may be integrated into a single integrated circuit chip with the computer/microprocessor 14 or embodied in a separate memory chip that is coupled to the computer/microprocessor 14. Alternatively and/or additionally, the software may be stored in non-volatile memory 12 and downloaded to a ROM memory upon system start-up or initialization for subsequent execution by the computer/microprocessor 14.

In alternative embodiments, the microprocessor and/or software functionality may be embodied in an Application Specific Integrated Circuit (ASIC) or other type of programmable digital signal processing circuit (such as programmable logic devices (PLD)) known in the art. The actual implementation of the memory 12, the computer/microprocessor 14, and associated circuitry such as buffers, ROM, peripheral interfaces, data busses, etc., may be implemented in various ways and configurations, in order to achieve the functionality of the present invention. Such various ways and configurations would constitute design choices by those of ordinary skill in the art in accordance with known principles, techniques and efficiency (cost and performance) considerations.

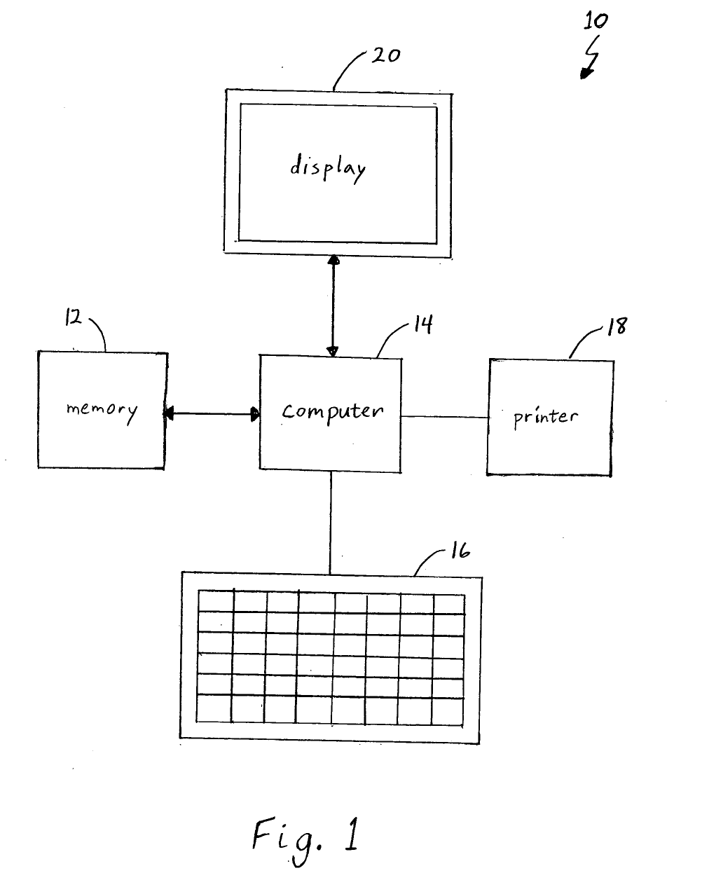

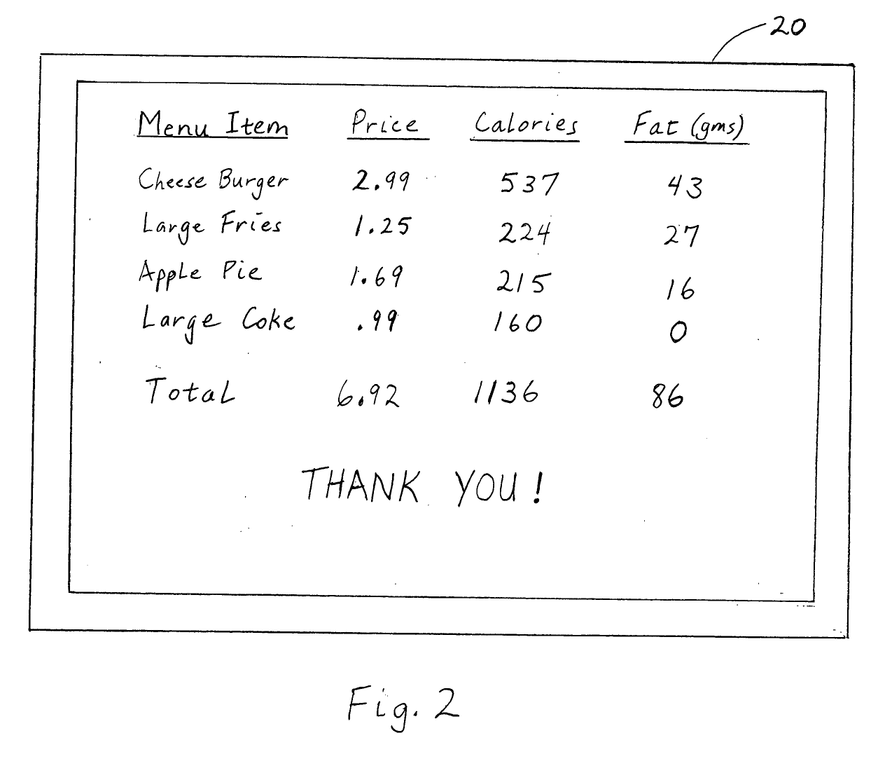

FIG. 2 illustrates exemplary information that may be provided by a display monitor 20 of FIG. 1, in accordance with one embodiment of the invention. As shown in FIG. 2, the display 20 shows each menu item ordered by a customer and entered by a restaurant employee/cashier via the keyboard 16 (FIG. 1). In the example shown, the selected menu items include: a cheese burger, large fries, an apple pie and a large coke. The display 20 further displays corresponding price information and values for calories and fat content for each menu item. The display 20 further displays a price total ($6.92), total calories (1136) and total fat (86 grams) for the entire meal, as calculated by the computer 14 (FIG. 1). In further embodiments, one or more other nutritional parameters (e.g., carbohydrate, cholesterol, sodium, etc.), as requested by the customer and/or desired by a restaurant employee/manager, may be added to the display 20 and/or replace default nutritional parameters (e.g., calories and fat content).

The software and associated circuitry for displaying the information described above are well known in the art and easily implemented in accordance with the present invention. In one embodiment the associated circuitry comprises a character generator, coupled to processing circuitry in the computer 14, for displaying information on the display 20. Alternatively, the associated circuitry may comprise a bit-map graphics generator for generating and displaying alphanumeric information as well as graphics on the display 20. These and other types of associated circuitry may be implemented, based on design considerations, by those of ordinary skill in the art, in accordance with the functions of the invention described herein.

Various preferred embodiments of the invention have been described above. However, it is understood that these various embodiments are exemplary only and should not limit the scope of the invention. Various modifications to the preferred embodiments would be readily apparent to and easily implemented by those of ordinary skill in the art, without undue experimentation. It is intended that such various modifications and equivalents be encompassed within the scope of the invention as set forth in the following claims.

What is claimed is:

1. A method of selling food, comprising:
receiving an order for at least one menu food item from a customer;
accessing a memory to retrieve price information and at least one nutritional parameter value for the at least one menu food item; and
automatically providing the price information and the at least one nutritional parameter value to the customer.

2. The method of claim 1 wherein the step of automatically providing the price information and the at least one nutritional parameter value comprises displaying the price information and the at least one nutritional parameter value on a display viewable by the customer.

3. The method of claim 2 wherein the display comprises a drive-thru ordering display.

4. The method of claim 1 wherein the step of automatically providing the price information and the at least one nutritional parameter value comprises printing the price information and the at least one nutritional parameter value on a receipt provided to the customer.

5. The method of claim 1 wherein the at least one menu food item comprises a plurality of menu food items and the at least one nutritional parameter value comprises a total nutritional parameter value for the plurality of menu food items.

6. The method of claim 1 further comprising:
receiving a request from the customer for a particular nutritional parameter value;
accessing the memory for the particular nutritional parameter value corresponding to the at least one menu food item; and
automatically providing the particular nutritional parameter value to the customer.

7. The method of claim 6 wherein the particular nutritional parameter value comprises a total nutritional parameter value for the at least one menu food item.

8. A method of selling food, comprising:
receiving an order for at least one menu food item from a customer;
receiving a request from the customer for at least one nutritional parameter value;
accessing a memory to retrieve price information and the at least one nutritional parameter value for the at least one menu food item; and
automatically providing the price information and the at least one nutritional parameter value to the customer.

9. The method of claim 8 wherein the step of automatically providing the price information and the at least one nutritional parameter value comprises displaying the price information and the at least one nutritional parameter value on a display viewable by the customer.

10. The method of claim 9 wherein the display comprises a drive-thru ordering display.

11. The method of claim 8 wherein the step of automatically providing the price information and the at least one nutritional parameter value comprises printing the price information and the at least one nutritional parameter value on a receipt provided to the customer.

12. The method of claim 8 wherein the at least one menu food item comprises a plurality of menu food items and the at least one nutritional parameter value comprises a total nutritional parameter value for the plurality of menu food items.

13. A system for selling food, comprising:
means for selecting at least one menu food item ordered by a customer;
means for accessing a memory to retrieve price information and at least one nutritional parameter value for the at least one menu food item; and
means for automatically providing the price information and the at least one nutritional parameter value to the customer.

14. The system of claim 13 wherein the means for automatically providing the price information and the at least one nutritional parameter value comprises means for displaying the price information and the at least one nutritional parameter value on a display viewable by the customer.

15. The system of claim 14 wherein the means for displaying comprises a drive-thru ordering display.

16. The system of claim 13 wherein the means for automatically providing the price information and the at least one nutritional parameter value comprises means for printing the price information and the at least one nutritional parameter value on a receipt provided to the customer.

17. The system of claim 13 wherein the at least one menu food item comprises a plurality of menu food items and the at least one nutritional parameter value comprises a total nutritional parameter value for the plurality of menu food items.

18. The system of claim 13 further comprising:
means for selecting a particular nutritional parameter requested by the customer;
means for accessing the memory to retrieve a nutritional parameter value corresponding to the particular nutritional parameter for the at least one menu food item; and
means for automatically providing the retrieved nutritional parameter value to the customer.

19. The system of claim 18 further comprising means for calculating a total nutritional value corresponding to the particular nutritional parameter for the at least one menu food item, wherein said means for automatically providing also provides the total nutritional value to the customer.
